(19) United States
(12) Patent Application Publication
(10) Pub. No.: US 2023/0206554 A1
(43) Pub. Date: Jun. 29, 2023

(54) MAPPING METHOD, ELECTRONIC DEVICE AND READABLE STORAGE MEDIUM

(71) Applicant: BEIJING BAIDU NETCOM SCIENCE TECHNOLOGY CO., LTD., Beijing (CN)

(72) Inventors: Xiaobo WAN, Beijing (CN); Yueqiang DONG, Beijing (CN); Kang WANG, Beijing (CN); Xianpeng MENG, Beijing (CN)

(73) Assignee: BEIJING BAIDU NETCOM SCIENCE TECHNOLOGY CO., LTD., Beijing (CN)

(21) Appl. No.: 17/929,245

(22) Filed: Sep. 1, 2022

(30) Foreign Application Priority Data
Dec. 23, 2021 (CN) 202111587894.5

(51) Int. Cl. G06T 17/05

(52) U.S. Cl. CPC G06T 17/05

(57) ABSTRACT

A mapping method, an electronic device and a readable storage medium, which relate to the fields of map generation technologies, indoor localization technologies, are disclosed. The mapping method includes: acquiring current frame point cloud data of a target scenario to obtain a submap sequence and an active submap corresponding to the current frame point cloud data; acquiring initial posture data of the current frame point cloud data, and obtaining target posture data of the current frame point cloud data according to the initial posture data and the active submap; obtaining at least one posture constraint condition according to the target posture data of the current frame point cloud data and the submap sequence; and performing posture optimization on the submap sequence according to the at least one posture constraint condition, and obtaining a mapping result of the target scenario according to the submap sequence after the posture optimization.

The present disclosure claims the priority and benefit of Chinese Patent Application No. 202111587894.5, filed on Dec. 23, 2021, entitled “MAPPING METHOD AND APPARATUS, ELECTRONIC DEVICE AND READABLE STORAGE MEDIUM”. The disclosure of the above application is incorporated herein by reference in its entirety.

### TECHNICAL FIELD

The present disclosure relates to the field of data processing technologies, particularly to the fields of map generation technologies, indoor localization technologies, and more particularly to a mapping method, an electronic device and a readable storage medium.

### BACKGROUND

In common scenarios, such as an office building, an indoor lobby, or the like, a relatively accurate mapping result may be obtained by constructing a map using a simultaneous localization and mapping (SLAM) technology. However, in some special scenarios, such as a non-loop gallery in a hotel, a tunnel, or the like, when the map is constructed using the SLAM technology, the obtained mapping result has problems of deformation, shadows, large errors, or the like.

### SUMMARY

According to a first aspect of the present disclosure, there is provided a mapping method, including: acquiring current frame point cloud data of a target scenario to obtain a submap sequence and an active submap corresponding to the current frame point cloud data; acquiring initial posture data of the current frame point cloud data, and obtaining target posture data of the current frame point cloud data according to the initial posture data and the active submap; obtaining at least one posture constraint condition according to the target posture data of the current frame point cloud data and the submap sequence; and performing posture optimization on the submap sequence according to the at least one posture constraint condition, and obtaining a mapping result of the target scenario according to the submap sequence after the posture optimization.

According to a second aspect of the present disclosure, there is provided an electronic device, including: at least one processor; and a memory connected with the at least one processor communicatively, where the memory stores instructions executable by the at least one processor to enable the at least one processor to perform the method as mentioned above.

According to a third aspect of the present disclosure, there is provided a non-transitory computer readable storage medium with computer instructions stored thereon, where the computer instructions are used for causing a computer to perform the method as mentioned above.

It should be understood that the statements in this section are not intended to identify key or critical features of the embodiments of the present disclosure, nor limit the scope of the present disclosure. Other features of the present disclosure will become apparent from the following description.

### BRIEF DESCRIPTION OF THE DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure; and

FIG. 4 is a block diagram of an electronic device configured to implement a mapping method according to some embodiments of the present disclosure.

### DETAILED DESCRIPTION OF EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and mechanisms are omitted in the descriptions below.

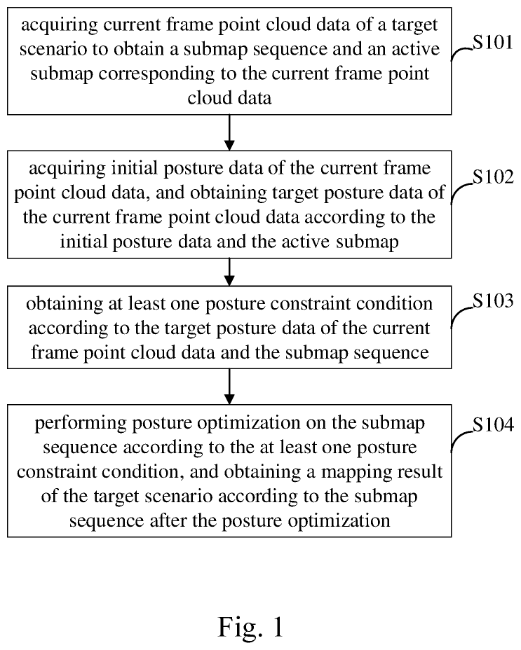

FIG. 1 is a schematic diagram according to a first embodiment of the present disclosure. As shown in FIG. 1, a mapping method according to this embodiment includes the following steps:

S101: acquiring current frame point cloud data of a target scenario to obtain a submap sequence and an active submap corresponding to the current frame point cloud data;

S102: acquiring initial posture data of the current frame point cloud data, and obtaining target posture data of the current frame point cloud data according to the initial posture data and the active submap;

S103: obtaining at least one posture constraint condition according to the target posture data of the current frame point cloud data and the submap sequence; and

S104: performing posture optimization on the submap sequence according to the at least one posture constraint condition, and obtaining a mapping result of the target scenario according to the submap sequence after the posture optimization.

The mapping method according to this embodiment includes: firstly, acquiring the current frame point cloud data of the target scenario to obtain the submap sequence and the active submap corresponding to the current frame point cloud data; secondly, obtaining the target posture data of the current frame point cloud data according to the acquired initial posture data of the current frame point cloud data and the active submap; thirdly, obtaining the at least one posture constraint condition according to the target posture data of the current frame point cloud data and the submap sequence; and finally, performing the posture optimization on the submap sequence using the at least one posture constraint condition, thereby obtaining the mapping result of the target scenario according to the submap sequence after the posture optimization; in this embodiment, according to the acquired current frame point cloud data of the target scenario, a map may be constructed in any scenario, such as a scenario with highly-consistent features, and precision of the constructed map may be effectively improved.

In this embodiment, during the S101 of acquiring current frame point cloud data of a target scenario, point cloud data collected by a laser radar sensor mounted on a robot at a current moment when the robot moves in the target scenario may be used as the current frame point cloud data; the current frame point cloud data acquired in S101 in this embodiment for example is the point cloud data collected by the laser radar sensor on the robot rotating by one circle at the current moment.

It may be understood that the target scenario in this embodiment may be a scenario with highly-consistent features, such as a non-loop gallery in a hotel, a tunnel, or the like, or may be any other scenario.

In this embodiment, after the S101 of acquiring current frame point cloud data of a target scenario, the submap sequence and the active submap corresponding to the acquired current frame point cloud data may be obtained.

It may be understood that, in this embodiment, before the S101 of obtaining a submap sequence and an active submap corresponding to the current frame point cloud data, the current frame point cloud data may be down-sampled, thereby reducing a number of point clouds in the point cloud data and meanwhile guaranteeing integrity of a point cloud profile.

In this embodiment, the submap sequence obtained in the S101 includes at least one submap, and different submaps include point cloud data which has a same quantity and is collected at different moments; in this embodiment, the active submap obtained in the S101 is composed of a certain quantity of point cloud data, and the point cloud data included in the active submap is dynamically changed with acquirement of the current frame point cloud data.

For example, in this embodiment, during the S101 of obtaining a submap sequence corresponding to the current frame point cloud data, an adopted optional implementation may include: acquiring a first data quantity of point cloud data contained in a current submap in the submap sequence; and in response to determining that the acquired first data quantity is less than a first quantity threshold, adding the current frame point cloud data into the current submap, and in response to determining that the acquired first data quantity is not less than the first quantity threshold, adding the current frame point cloud data into a submap in the submap sequence located behind the current submap.

In other words, in this embodiment, according to a comparison result between the first data quantity of the point cloud data included in the current submap and the first quantity threshold, the current frame point cloud data is added into an appropriate submap in the submap sequence, thereby achieving a purpose of updating the submap sequence each time the current frame point cloud data is acquired, and ensuring that the submap located before the current submap in the submap sequence is not changed.

In this embodiment, during the S101 of obtaining an active submap corresponding to the current frame point cloud data, an adopted optional implementation may include: adding the current frame point cloud data into the active submap; acquiring a second data quantity of point cloud data in the active submap and/or a data distance between head point cloud data and tail point cloud data; and deleting the tail point cloud data in the active submap in response to determining that a preset requirement is not met by the acquired second data quantity and/or the data distance.

In this embodiment, the preset requirement that the second data quantity is greater than or equal to a second quantity threshold and/or the data distance is greater than or equal to a distance threshold may be used in the S101.

In other words, in this embodiment, the obtained active submap corresponding to the current frame point cloud data is dynamically changed, and by maintaining one dynamically-changed active submap, correlation between the obtained active submap and the current frame point cloud data may be improved.

In this embodiment, after the S101 of acquiring current frame point cloud data of a target scenario to obtain a submap sequence and an active submap corresponding to the current frame point cloud data, the S102 of acquiring initial posture data of the current frame point cloud data, and obtaining target posture data of the current frame point cloud data according to the initial posture data and the active submap is executed.

In this embodiment, the posture data involved in the S102 includes numerical values corresponding to different directions when the robot moves in the target scenario; if the constructed map is a two-dimensional map, the posture data includes numerical values corresponding to an x direction, a y direction and a heading direction; if the constructed map is a three-dimensional map, the posture data includes numerical values corresponding to an x direction, a y direction, a z direction, a yaw direction, a pitch direction and a roll direction.

In this embodiment, during the S102 of acquiring initial posture data of the current frame point cloud data, an adopted optional implementation may include: acquiring first data collected by an odometer and second data collected by an inertia measurement unit at a current moment, the current moment in this embodiment being a moment of acquiring the current frame point cloud data; and taking the posture data obtained according to the acquired first data and second data as the initial posture data of the current frame point cloud data.

In this embodiment, the odometer and the inertia measurement unit are sensors mounted on the robot and configured to collect data, such as moving distances, rotation angles, acceleration, angular speeds, or the like, of the robot at different moments.

In other words, in this embodiment, the initial posture data of the current frame point cloud data may be acquired according to data collected by other sensors mounted on the robot, thus improving accuracy of the acquired initial posture data.

In addition, in this embodiment, during the S102 of acquiring initial posture data of the current frame point cloud data, target posture data of previous frame point cloud data of the current frame point cloud data may be directly used as the initial posture data of the current frame point cloud data.

For example, in this embodiment, during the S102 of obtaining target posture data of the current frame point cloud data according to the initial posture data and the active submap, an adopted optional implementation may include: generating a first candidate solution corresponding to each direction according to the numerical value in each direction in the initial posture data; permuting and combining the first candidate solutions in all directions to obtain multiple groups of first candidate posture data; calculating respectively matching scores between the obtained multiple groups of first candidate posture data and the active submap; and taking the first candidate posture data corresponding to the maximum matching score as the target posture data of the current frame point cloud data.

For example, if the initial posture data includes numerical values (1, 1, 50°) corresponding to the x direction, the y direction and the heading direction respectively, during execution of the S102 in this embodiment, the first candidate solutions 0.9 and 1.1 corresponding to the x direction may be generated according to the numerical value 1 corresponding to the x direction, the first candidate solutions 0.8 and 1.2 corresponding to the y direction may be generated according to the numerical value 1 corresponding to the y direction, and the first candidate solutions 49° and 51° corresponding to the heading direction may be generated according to the numerical value 50° corresponding to the heading direction, such that the first candidate posture data obtained by permutation and combination may be (0.9, 1.2, 49°), (0.9, 0.8, 49°), and so on.

In other words, in this embodiment, the target posture data of the current frame point cloud data is obtained according to the first candidate posture data obtained from the initial posture data of the current frame point cloud da ta, as well as the active submap corresponding to the current frame point cloud data, thus improving accuracy of the obtained target posture data.

In this embodiment, after the S102 of obtaining target posture data of the current frame point cloud data, the S103 of obtaining at least one posture constraint condition according to the target posture data of the current frame point cloud data and the submap sequence is executed.

For example, in this embodiment, during the S103 of obtaining at least one posture constraint condition according to the target posture data of the current frame point cloud data and the submap sequence, an adopted optional implementation may include: generating a second candidate solution corresponding to each direction according to a numerical value in each direction in the target posture data of the current frame point cloud data; permuting and combining the second candidate solutions in all directions to obtain multiple groups of second candidate posture data; calculating respectively matching scores between the obtained multiple groups of second candidate posture data and each submap in the submap sequence; for each submap, taking the second candidate posture data corresponding to the maximum matching score as constraint posture data of the submap corresponding to the current frame point cloud data; and obtaining the at least one posture constraint condition according to the target posture data and the constraint posture data corresponding to each submap.

In other words, in this embodiment, the second candidate posture data corresponding to the target posture data and the submaps in the submap sequence are acquired to obtain the constraint posture data corresponding to each submap, and then, the at least one posture constraint condition is obtained according to the target posture data and the constraint posture data corresponding to each submap, thus improving accuracy of the obtained posture constraint condition.

For further improvement of the accuracy of the obtained at least one posture constraint condition, in this embodiment, during the S103 of calculating respectively matching scores between the obtained second candidate posture data and the submaps in the submap sequence, the method may also include the following steps: setting resolution of each submap in the submap sequence into preset resolution, the preset resolution in this embodiment being greater than current resolution of the submap; and calculating the matching score between the obtained second candidate posture data and each submap with the preset resolution.

In this embodiment, after the S103 of obtaining at least one posture constraint condition, the S104 of performing posture optimization on the submap sequence according to the at least one posture constraint condition, and obtaining a mapping result of the target scenario according to the submap sequence after the posture optimization is executed.

It may be understood that, in this embodiment, the mapping result obtained in the S104 is a mapping result corresponding to the moment when the current frame point cloud data is acquired, such that in this embodiment, the complete mapping result of the target scenario may be generated according to the current frame point cloud data corresponding to different moments and acquired in the process of continuous movement of the robot in the target scenario.

In this embodiment, during the S104 of performing posture optimization on the submap sequence according to the at least one posture constraint condition, all point cloud data, including both the current frame point cloud data and historical frame point cloud data, included in each submap in the submap sequence is optimized.

It may be understood that, in this embodiment, during the S104 of performing posture optimization on the submap sequence according to the at least one posture constraint condition, an existing open source optimization library, for example, a gtsam optimization library, may be used to perform the posture optimization.

In this embodiment, after the S104 of completing posture optimization of each submap in the submap sequence, the submaps in the submap sequence may be spliced, and a splicing result is used as the mapping result of the target scenario.

In addition, in this embodiment, during the S104 of performing posture optimization on the submap sequence according to the at least one posture constraint condition, a beacon posture of a known beacon in the target scenario may also be acquired, and then, the posture optimization is performed on the submap sequence according to the at least one posture constraint condition and the beacon posture.

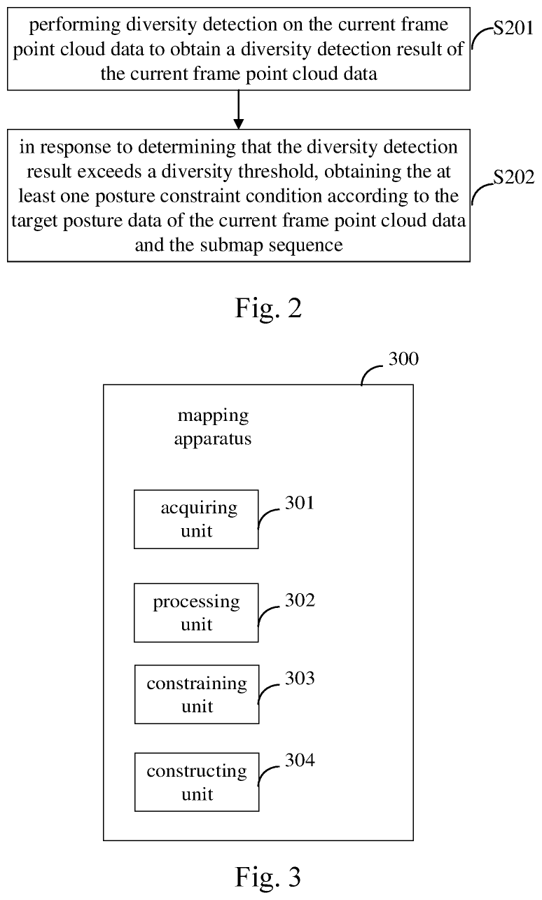

FIG. 2 is a schematic diagram according to a second embodiment of the present disclosure. As shown in FIG. 2, in this embodiment, the S103 of obtaining at least one posture constraint condition according to the target posture data of the current frame point cloud data and the submap sequence specially includes the following steps:

S201: performing diversity detection on the current frame point cloud data to obtain a diversity detection result of the current frame point cloud data; and

S202: in response to determining that the diversity detection result exceeds a diversity threshold, obtaining the at least one posture constraint condition according to the target posture data of the current frame point cloud data and the submap sequence.

In other words, in this embodiment, before the posture constraint condition is obtained, the diversity detection is performed on the current frame point cloud data, such that after the diversity detection result is determined to meet a certain condition, the posture constraint condition is determined, thereby solving a problem of low accuracy of the constraint condition caused by feature consistency when the map is constructed in the scenario with highly-consistent features, and improving the accuracy of the obtained posture constraint condition.

For example, in this embodiment, during the S201 of performing diversity detection on the current frame point cloud data to obtain a diversity detection result of the current frame point cloud data, an adopted optional implementation may include: traversing each point in the current frame point cloud data to obtain curvature of each point; determining a feature type of each point according to the curvature of each point; and taking the number of different feature types obtained according to the feature type of each point as the diversity detection result of the current frame point cloud data.

In this embodiment, during the S201 of determining the feature type of each point according to the curvature of each point, the feature types may be determined according to preset curvature thresholds corresponding to different feature types.

FIG. 3 is a schematic diagram according to a third embodiment of the present disclosure. As shown in FIG. 3, a mapping apparatus 300 according to this embodiment includes:

an acquiring unit 301 configured to acquire current frame point cloud data of a target scenario to obtain a submap sequence and an active submap corresponding to the current frame point cloud data;

a processing unit 302 configured to acquire initial posture data of the current frame point cloud data, and obtain target posture data of the current frame point cloud data according to the initial posture data and the active submap;

a constraining unit 303 configured to obtain at least one posture constraint condition according to the target posture data of the current frame point cloud data and the submap sequence; and

a constructing unit 304 configured to perform posture optimization on the submap sequence according to the at least one posture constraint condition, and obtain a mapping result of the target scenario according to the submap sequence after the posture optimization.

When the acquiring unit 301 acquires the current frame point cloud data of the target scenario, point cloud data collected by a laser radar sensor mounted on a robot at a current moment when the robot moves in the target scenario may be used as the current frame point cloud data; the current frame point cloud data acquired by the acquiring unit 301 is for example the point cloud data collected by the laser radar sensor on the robot rotating by one circle at the current moment.

After acquiring the current frame point cloud data of the target scenario, the acquiring unit 301 obtains the submap sequence and the active submap corresponding to the acquired current frame point cloud data.

It may be understood that, before obtaining the submap sequence and the active submap corresponding to the current frame point cloud data, the acquiring unit 301 may further down-sample the current frame point cloud data, thereby reducing a number of point clouds in the point cloud data and meanwhile guaranteeing integrity of a point cloud profile.

The submap sequence obtained by the acquiring unit 301 includes at least one submap, and different submaps include point cloud data which has a same quantity and is collected at different moments; the active submap obtained by the acquiring unit 301 is composed of a certain quantity of point cloud data, and the point cloud data included in the active submap is dynamically changed with acquirement of the point cloud data.

For example, when the acquiring unit 301 obtains the submap sequence corresponding to the current frame point cloud data, an adopted optional implementation may include: acquiring a first data quantity of point cloud data contained in a current submap in the submap sequence; and in response to determining that the acquired first data quantity is less than a first quantity threshold, adding the current frame point cloud data into the current submap, and in response to determining that the acquired first data quantity is not less than the first quantity threshold, adding the current frame point cloud data into a submap in the submap sequence located behind the current submap.

In other words, according to a comparison result between the first data quantity of the point cloud data included in the current submap and the first quantity threshold, the acquiring unit 301 adds the current frame point cloud data into an appropriate submap in the submap sequence, thereby achieving a purpose of updating the submap sequence each time the current frame point cloud data is acquired, and ensuring that the submap located before the current submap in the submap sequence is not changed.

When the acquiring unit 301 obtains the active submap corresponding to the current frame point cloud data, an adopted optional implementation may include: adding the current frame point cloud data into the active submap; acquiring a second data quantity of point cloud data in the active submap and/or a data distance between head point cloud data and tail point cloud data; and deleting the tail point cloud data in the active submap in response to determining that a preset requirement is not met by the acquired second data quantity and/or the data distance.

The preset requirement that the second data quantity is greater than or equal to a second quantity threshold and/or the data distance is greater than or equal to a distance threshold may be used for the acquiring unit 301.

In other words, the active submap obtained by the acquiring unit 301 and corresponding to the current frame point cloud data is dynamically changed, and by maintaining one dynamically-changed active submap, correlation between the obtained active submap and the current frame point cloud data may be improved.

In this embodiment, after the acquiring unit 301 acquires the current frame point cloud data of the target scenario to obtain the submap sequence and the active submap corresponding to the current frame point cloud data, the processing unit 302 acquires the initial posture data of the current frame point cloud data, and obtains the target posture data of the current frame point cloud data according to the initial posture data and the active submap.

The posture data involved by the processing unit 302 includes numerical values corresponding to different directions when the robot moves in the target scenario; if the constructed map is a two-dimensional map, the posture data includes numerical values corresponding to an x direction, a y direction and a heading direction; if the constructed map is a three-dimensional map, the posture data includes numerical values corresponding to an x direction, a y direction, a z direction, a yaw direction, a pitch direction and a roll direction.

When the processing unit 302 acquires the initial posture data of the current frame point cloud data, an adopted optional implementation may include: acquiring first data collected by an odometer and second data collected by an inertia measurement unit at a current moment; and taking the posture data obtained according to the acquired first data and second data as the initial posture data of the current frame point cloud data.

In other words, the processing unit 302 may acquire the initial posture data of the current frame point cloud data according to data collected by other sensors mounted on the robot, thus improving accuracy of the acquired initial posture data.

In addition, when the processing unit 302 acquires the initial posture data of the current frame point cloud data, target posture data of previous frame point cloud data of the current frame point cloud data may be directly used as the initial posture data of the current frame point cloud data.

For example, when the processing unit 302 obtains the target posture data of the current frame point cloud data according to the initial posture data and the active submap, an adopted optional implementation may include: generating a first candidate solution corresponding to each direction according to the numerical value in each direction in the initial posture data; permuting and combining the first candidate solutions in all directions to obtain multiple groups of first candidate posture data; calculating respectively matching scores between the obtained first candidate posture data and the active submap; and taking the first candidate posture data corresponding to the maximum matching score as the target posture data of the current frame point cloud data.

In other words, the processing unit 302 obtains the target posture data of the current frame point cloud data according to the first candidate posture data obtained from the initial posture data of the current frame point cloud data, as well as the active submap corresponding to the current frame point cloud data, thus improving accuracy of the obtained target posture data.

In this embodiment, after the processing unit 302 obtains the target posture data of the current frame point cloud data, the constraining unit 303 obtains the at least one posture constraint condition according to the target posture data of the current frame point cloud data and the submap sequence.

When the constraining unit 303 obtains the at least one posture constraint condition according to the target posture data of the current frame point cloud data and the submap sequence, an adopted optional implementation may include: performing diversity detection on the current frame point cloud data to obtain a diversity detection result of the current frame point cloud data; and in response to determining that the diversity detection result exceeds a diversity threshold, obtaining the at least one posture constraint condition according to the target posture data of the current frame point cloud data and the submap sequence.

In other words, before obtaining the posture constraint condition, the constraining unit 303 may perform the diversity detection on the current frame point cloud data, such that after the diversity detection result is determined to meet a certain condition, the posture constraint condition is determined, thereby solving a problem of low accuracy of the constraint condition caused by feature consistency when the map is constructed in the scenario with highly-consistent features, and improving the accuracy of the obtained posture constraint condition.

For example, when the constraining unit 303 performs the diversity detection on the current frame point cloud data to obtain the diversity detection result of the current frame point cloud data, an adopted optional implementation may include: traversing each point in the current frame point cloud data to obtain curvature of each point; determining a feature type of each point according to the curvature of each point; and taking the number of different feature types obtained according to the feature type of each point as the diversity detection result of the current frame point cloud data.

When the constraining unit 303 determines the feature type of each point according to the curvature of each point, the feature types may be determined according to preset curvature thresholds corresponding to different feature types.

For example, when the constraining unit 303 obtains the at least one posture constraint condition according to the target posture data of the current frame point cloud data and the submap sequence, an adopted optional implementation may include: generating a second candidate solution corresponding to each direction according to a numerical value in each direction in the target posture data of the current frame point cloud data; permuting and combining the second candidate solutions in all directions to obtain multiple groups of second candidate posture data; calculating respectively matching scores between the obtained second candidate posture data and each submap in the submap sequence; for each submap, taking the second candidate posture data corresponding to the maximum matching score as constraint posture data of the submap corresponding to the current frame point cloud data; and obtaining the at least one posture constraint condition according to the target posture data and the constraint posture data corresponding to each submap.

In other words, the constraining unit 303 acquires the second candidate posture data corresponding to the target posture data and the submaps in the submap sequence to obtain the constraint posture data corresponding to each submap, and then obtains the at least one posture constraint condition according to the target posture data and the constraint posture data corresponding to each submap, thus improving accuracy of the obtained posture constraint condition.

For further improvement of the accuracy of the obtained at least one posture constraint condition, when calculating the matching scores between the obtained second candidate posture data and the submaps in the submap sequence respectively, the constraining unit 303 may further: set resolution of each submap in the submap sequence into preset resolution; and calculate respectively the matching score between the obtained second candidate posture data and each submap with the preset resolution.

In this embodiment, after the constraining unit 303 obtains the at least one posture constraint condition, the constructing unit 304 performs the posture optimization on the submap sequence according to the at least one posture constraint condition, and obtains the mapping result of the target scenario according to the submap sequence after the posture optimization.

When performing the posture optimization on the submap sequence according to the at least one posture constraint condition, the constructing unit 304 optimizes all point cloud data, including both the current frame point cloud data and historical frame point cloud data, included in each submap in the submap sequence.

It may be understood that when the constructing unit 304 performs the posture optimization on the submap sequence according to the at least one posture constraint condition, an existing optimization library, for example, a gtsam optimization library, may be used to perform the posture optimization.

After completing the posture optimization of each submap in the submap sequence, the constructing unit 304 may splice the submaps in the submap sequence, and use a splicing result as the mapping result of the target scenario.

In addition, when performing the posture optimization on the submap sequence according to the at least one posture constraint condition, the constructing unit 304 may further acquire a beacon posture of a known beacon in the target scenario, and then perform the posture optimization on the submap sequence according to the at least one posture constraint condition and the beacon posture.

In the technical solution of the present disclosure, the acquisition, storage and application of involved user personal information are in compliance with relevant laws and regulations, and do not violate public order and good customs.

According to the embodiment of the present disclosure, there are also provided an electronic device, a readable storage medium and a computer program product.

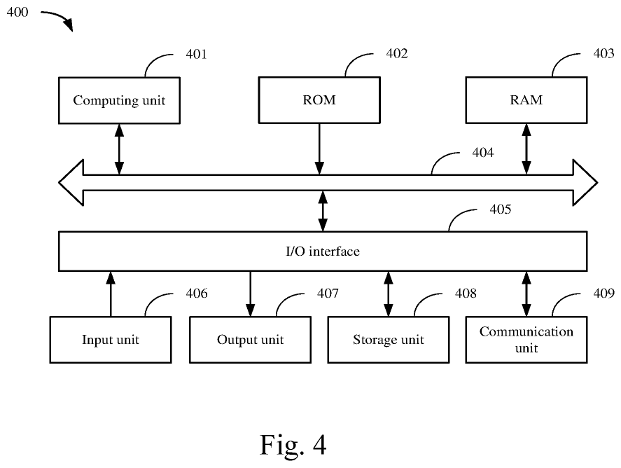

FIG. 4 is a block diagram of an electronic device configured to implement a mapping method according to the embodiment of the present disclosure. The electronic device is intended to represent various forms of digital computers, such as laptop computers, desktop computers, workstations, personal digital assistants, servers, blade servers, mainframe computers, and other appropriate computers. The electronic device may also represent various forms of mobile devices, such as personal digital assistants, cellular telephones, smart phones, wearable devices, and other similar computing devices. The components shown herein, their connections and relationships, and their functions, are meant to be exemplary only, and are not meant to limit implementation of the present disclosure described and/or claimed herein.

As shown in FIG. 4, the device 400 includes a computing unit 401 which may perform various appropriate actions and processing operations according to a computer program stored in a read only memory (ROM) 402 or a computer program loaded from a storage unit 408 into a random access memory (RAM) 403. Various programs and data necessary for the operation of the device 400 may be also stored in the RAM 403. The computing unit 401, the ROM 402, and the RAM 403 are connected with one other through a bus 404. An input/output (I/O) interface 405 is also connected to the bus 404.

The multiple components in the device 400 are connected to the I/O interface 405, and include: an input unit 406, such as a keyboard, a mouse, or the like; an output unit 407, such as various types of displays, speakers, or the like; the storage unit 408, such as a magnetic disk, an optical disk, or the like; and a communication unit 409, such as a network card, a modem, a wireless communication transceiver, or the like. The communication unit 409 allows the device 400 to exchange information/data with other devices through a computer network, such as the Internet, and/or various telecommunication networks.

The computing unit 401 may be a variety of general and/or special purpose processing components with processing and computing capabilities. Some examples of the computing unit 401 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 401 performs the methods and processing operations described above, such as the mapping method. For example, in some embodiments, the mapping method may be implemented as a computer software program tangibly contained in a machine readable medium, such as the storage unit 408.

In some embodiments, part or all of the computer program may be loaded and/or installed into the device 400 via the ROM 402 and/or the communication unit 409. When the computer program is loaded into the RAM 403 and executed by the computing unit 401, one or more steps of the mapping method described above may be performed. Alternatively, in other embodiments, the computing unit 401 may be configured to perform the mapping method by any other suitable means (for example, by means of firmware).

Various implementations of the systems and technologies described herein may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input device, and at least one output device.

Program codes for implementing the method according to the present disclosure may be written in any combination of one or more programming languages. These program codes may be provided to a processor or a controller of a general purpose computer, a special purpose computer, or other programmable mapping devices, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display device (for example, a cathode ray tube (CRT) or liquid crystal display (LCD) monitor) for displaying information to a user; and a keyboard and a pointing device (for example, a mouse or a trackball) by which a user may provide input for the computer. Other kinds of devices may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server, also called a cloud computing server or a cloud host, and is a host product in a cloud computing service system, so as to overcome the defects of high management difficulty and weak service expansibility in conventional physical host and virtual private server (VPS) service. The server may also be a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A mapping method, comprising:
acquiring current frame point cloud data of a target scenario to obtain a submap sequence and an active submap corresponding to the current frame point cloud data;
acquiring initial posture data of the current frame point cloud data, and obtaining target posture data of the current frame point cloud data according to the initial posture data and the active submap;
obtaining at least one posture constraint condition according to the target posture data of the current frame point cloud data and the submap sequence; and
performing posture optimization on the submap sequence according to the at least one posture constraint condition, and obtaining a mapping result of the target scenario according to the submap sequence after the posture optimization.

2. The method according to claim 1, wherein the obtaining the submap sequence corresponding to the current frame point cloud data comprises:
acquiring a first data quantity of point cloud data contained in a current submap in the submap sequence; and
in response to determining that the first data quantity is less than a first quantity threshold, adding the current frame point cloud data into the current submap, and in response to determining that the first data quantity is not less than the first quantity threshold, adding the current frame point cloud data into a submap in the submap sequence located behind the current submap.

3. The method according to claim 1, wherein the obtaining the active submap corresponding to the current frame point cloud data comprises:
adding the current frame point cloud data into the active submap;
acquiring a second data quantity of point cloud data in the active submap and/or a data distance between head point cloud data and tail point cloud data; and
deleting the tail point cloud data in the active submap in response to determining that a preset requirement is met by the second data quantity and/or the data distance.

4. The method according to claim 1, wherein the acquiring the initial posture data of the current frame point cloud data comprises:
acquiring first data collected by an odometer and second data collected by an inertia measurement unit at a current moment; and
taking the posture data obtained from the first data and the second data as the initial posture data of the current frame point cloud data.

5. The method according to claim 1, wherein the obtaining the target posture data of the current frame point cloud data according to the initial posture data and the active submap comprises:
generating a first candidate solution corresponding to each direction according to the numerical value in each direction in the initial posture data;
permuting and combining the first candidate solutions in all directions to obtain multiple groups of first candidate posture data;
calculating respectively matching scores between the multiple groups of first candidate posture data and the active submap; and
taking the first candidate posture data corresponding to a maximum matching score as the target posture data of the current frame point cloud data.

6. The method according to claim 1, wherein the obtaining the at least one posture constraint condition according to the target posture data of the current frame point cloud data and the submap sequence comprises:
performing diversity detection on the current frame point cloud data to obtain a diversity detection result of the current frame point cloud data; and
in response to determining that the diversity detection result exceeds a diversity threshold, obtaining the at least one posture constraint condition according to the target posture data of the current frame point cloud data and the submap sequence.

7. The method according to claim 1, wherein the obtaining the at least one posture constraint condition according to the target posture data of the current frame point cloud data and the submap sequence comprises:
generating a second candidate solution corresponding to each direction according to a numerical value in each direction in the target posture data of the current frame point cloud data;
permuting and combining the second candidate solutions in all directions to obtain multiple groups of second candidate posture data;
calculating respectively matching scores between the multiple groups of second candidate posture data and each submap in the submap sequence;
for each submap, taking the second candidate posture data corresponding to the maximum matching score as constraint posture data of the submap corresponding to the current frame point cloud data; and
obtaining the at least one posture constraint condition according to the target posture data and the constraint posture data corresponding to each submap.

8. The method according to claim 6, wherein the performing diversity detection on the current frame point cloud data to obtain the diversity detection result of the current frame point cloud data comprises:
traversing each point in the current frame point cloud data to obtain curvature of each point;
determining a feature type of each point according to the curvature of each point; and
taking the number of different feature types obtained according to the feature type of each point as the diversity detection result of the current frame point cloud data.

9. The method according to claim 7, wherein the calculating respectively the matching scores between the multiple groups of second candidate posture data and each submap in the submap sequence comprises:
setting resolution of each submap in the submap sequence into preset resolution; and
calculating respectively the matching scores between the multiple groups of second candidate posture data and each submap with the preset resolution.

10. An electronic device, comprising:
at least one processor; and
a memory connected with the at least one processor communicatively;
wherein the memory stores instructions executable by the at least one processor to enable the at least one processor to perform a mapping method comprising:
acquiring current frame point cloud data of a target scenario to obtain a submap sequence and an active submap corresponding to the current frame point cloud data;
acquiring initial posture data of the current frame point cloud data, and obtaining target posture data of the current frame point cloud data according to the initial posture data and the active submap;
obtaining at least one posture constraint condition according to the target posture data of the current frame point cloud data and the submap sequence; and
performing posture optimization on the submap sequence according to the at least one posture constraint condition, and obtaining a mapping result of the target scenario according to the submap sequence after the posture optimization.

11. The electronic device according to claim 10, wherein the obtaining the submap sequence corresponding to the current frame point cloud data comprises:
acquiring a first data quantity of point cloud data contained in a current submap in the submap sequence; and
in response to determining that the first data quantity is less than a first quantity threshold, adding the current frame point cloud data into the current submap, and in response to determining that the first data quantity is not less than the first quantity threshold, adding the current frame point cloud data into a submap in the submap sequence located behind the current submap.

12. The electronic device according to claim 10, wherein the obtaining the active submap corresponding to the current frame point cloud data comprises:
adding the current frame point cloud data into the active submap;
acquiring a second data quantity of point cloud data in the active submap and/or a data distance between head point cloud data and tail point cloud data; and
deleting the tail point cloud data in the active submap in response to determining that a preset requirement is met by the second data quantity and/or the data distance.

13. The electronic device according to claim 10, wherein the acquiring the initial posture data of the current frame point cloud data comprises:
acquiring first data collected by an odometer and second data collected by an inertia measurement unit at a current moment; and
taking the posture data obtained from the first data and the second data as the initial posture data of the current frame point cloud data.

14. The electronic device according to claim 10, wherein the obtaining the target posture data of the current frame point cloud data according to the initial posture data and the active submap comprises:
generating a first candidate solution corresponding to each direction according to the numerical value in each direction in the initial posture data;
permuting and combining the first candidate solutions in all directions to obtain multiple groups of first candidate posture data;
calculating respectively matching scores between the multiple groups of first candidate posture data and the active submap; and
taking the first candidate posture data corresponding to a maximum matching score as the target posture data of the current frame point cloud data.

15. The electronic device according to claim 10, wherein the obtaining the at least one posture constraint condition according to the target posture data of the current frame point cloud data and the submap sequence comprises:
performing diversity detection on the current frame point cloud data to obtain a diversity detection result of the current frame point cloud data; and
in response to determining that the diversity detection result exceeds a diversity threshold, obtaining the at least one posture constraint condition according to the target posture data of the current frame point cloud data and the submap sequence.

16. The electronic device according to claim 10, wherein the obtaining the at least one posture constraint condition according to the target posture data of the current frame point cloud data and the submap sequence comprises:
generating a second candidate solution corresponding to each direction according to a numerical value in each direction in the target posture data of the current frame point cloud data;
permuting and combining the second candidate solutions in all directions to obtain multiple groups of second candidate posture data;
calculating respectively matching scores between the multiple groups of second candidate posture data and each submap in the submap sequence;
for each submap, taking the second candidate posture data corresponding to the maximum matching score as constraint posture data of the submap corresponding to the current frame point cloud data; and
obtaining the at least one posture constraint condition according to the target posture data and the constraint posture data corresponding to each submap.

17. The electronic device according to claim 15, wherein the performing diversity detection on the current frame point cloud data to obtain the diversity detection result of the current frame point cloud data comprises:
traversing each point in the current frame point cloud data to obtain curvature of each point;
determining a feature type of each point according to the curvature of each point; and
taking the number of different feature types obtained according to the feature type of each point as the diversity detection result of the current frame point cloud data.

18. The electronic device according to claim 16, wherein the calculating respectively the matching scores between the multiple groups of second candidate posture data and each submap in the submap sequence comprises:
setting resolution of each submap in the submap sequence into preset resolution; and
calculating respectively the matching scores between the multiple groups of second candidate posture data and each submap with the preset resolution.

19. A non-transitory computer readable storage medium with computer instructions stored thereon, wherein the computer instructions are used for causing a computer to perform a mapping method comprising:
acquiring current frame point cloud data of a target scenario to obtain a submap sequence and an active submap corresponding to the current frame point cloud data;
acquiring initial posture data of the current frame point cloud data, and obtaining target posture data of the current frame point cloud data according to the initial posture data and the active submap;
obtaining at least one posture constraint condition according to the target posture data of the current frame point cloud data and the submap sequence; and
performing posture optimization on the submap sequence according to the at least one posture constraint condition, and obtaining a mapping result of the target scenario according to the submap sequence after the posture optimization.

20. The non-transitory computer readable storage medium according to claim 19, wherein the obtaining the submap sequence corresponding to the current frame point cloud data comprises:
acquiring a first data quantity of point cloud data contained in a current submap in the submap sequence; and
in response to determining that the first data quantity is less than a first quantity threshold, adding the current frame point cloud data into the current submap, and in response to determining that the first data quantity is not less than the first quantity threshold, adding the current frame point cloud data into a submap in the submap sequence located behind the current submap.
